(19) United States
(12) Patent Application Publication
(10) Pub. No.: US 2020/0040721 A1
(43) Pub. Date: Feb. 6, 2020

(54) CENTRAL MAINTENANCE APPARATUS OF SENSOR FOR GEOPHYSICAL EXPLORATION

(71) Applicant: AAT CO. LTD., Seongnam-si (KR)

(72) Inventors: Jihyang Choi, Songpa-gu (KR); Chang Shik Lee, Seongnam-si (KR); Kyu Jung Kim, Ansan-si (KR); Sang-Mook Lee, Seocho-gu (KR)

(73) Assignee: AAT CO. LTD., Seongnam-si (KR)

(21) Appl. No.: 16/154,791

(22) Filed: Oct. 9, 2018

(30) Foreign Application Priority Data
Aug. 3, 2018 (KR) 10-2018-0090981

(51) Int. Cl. E21B 47/01; G01V 13/00; G01V 3/18

(52) U.S. Cl. CPC E21B 47/01; G01V 3/18; G01V 13/00

(57) ABSTRACT

A central maintenance apparatus of sensor for geophysical exploration includes a body part cylindrically formed to wrap a circumference of a sensor rod; and a plurality of wing parts lengthwise formed at an outer wall of the body part in a convex, semi-elliptic shape with a predetermined width, and formed therein with a cavity, wherein the wing part is formed with a plurality of through holes passing through the cavity from an outside, and has a shape-changing elasticity when a pressure is applied to a direction of the body part. At this time, when an obstacle is encountered while moving inside a borehole, the wing part having a shape-changing elasticity can avoid the obstacle like sliding off the obstacle to allow the central maintenance apparatus of sensor to automatically rotate.

### PRIORITY INFORMATION

Pursuant to 35 U.S.C.§ 119 (a), this application claims the benefit of earlier filing date and right of priority to Korean Patent Application No.10-2018-0090981, filed on Aug. 3, 2018, the contents of which are hereby incorporated by reference in their entirety.

### BACKGROUND

The geophysical exploration is a method to determine the properties of a portion of the earth's subsurface and geological structure by directly and indirectly measuring and interpreting geophysical phenomenon caused by difference of physical properties of materials forming the atmosphere, which is applicable to various energy resources exploration such as oils, natural gases, metals and geothermal heat, soil for civil engineering and building resources fields and rock mechanics research, and pollution research of underground media.

Particularly, the geophysical logging method is a geophysical exploration continuously measuring physical properties of rock in response to depth by putting various geophysical measuring devices into borehole, and an exploration technique for obtaining useful information on hydrodynamic properties of subsurface and mechanical information of rock structure. The geophysical logging method may be classified, based on basic principle, into electric logging, radioactive logging, acoustic logging, induction logging, and other loggings.

When a borehole is drilled into subsurface for mineral resources exploration, environmental pollution detection, underground water survey, geothermal exploration and ground survey, a depth of borehole may be several meters to several kilometers depending on depth of exploration subjects, and size of borehole may be variably designed in response to exploration technologies.

When borehole is secured, a geophysical exploration sensor (hereinafter referred to as “sensor rod”) formed in a shape of a rod with several meters of length is descended or ascended to a floor of the borehole for image photographing inside the borehole and for geophysical measurement of ground, where accuracy of measured data can be increased only if the sensor rod moves along a center of borehole without being swayed to thereby secure a stable and reliable data.

Thus, it is essential to come along with a central maintenance apparatus of sensor for geophysical exploration in order to stably maintain a sensor rod in a center within the borehole.

However, the conventional central maintenance apparatus of sensor for geophysical exploration suffered from disadvantages in that a wing part connected to a portion coupled to a borehole sensor is susceptible to shocks and easily broken when countered with an obstacle within the borehole, thereby failing to function as a central maintenance device after being broken.

An example of a conventional central maintenance apparatus of a sensor for geophysical exploration is disclosed in Korean Patent Registration Gazette No.:10-1232808, registered date: Feb. 6, 2013.

Thus, it is desirable to provide a system that solves the aforementioned problems/disadvantages by providing a central maintenance apparatus of sensor for geophysical exploration configured to stably and continuously move a sensor rod at a center of borehole even if an obstacle is encountered within the borehole.

Furthermore, it is desirable to provide a central maintenance apparatus of sensor for geophysical exploration configured to be used once without recourse to re-use because of simple manufacturing process and reasonable manufacturing cost.

### BRIEF DESCRIPTION OF THE DRAWINGS

The accompanying drawings, which are included to provide a further understanding of the present disclosure and are incorporated in the present disclosure and constitute a part of this application, and together with the description, serve to explain the principle of the disclosure. In the drawings:

FIG. 1 is a schematic view illustrating an example of a conventional central maintenance apparatus of sensor for geophysical exploration;

FIG. 2 is a schematic view illustrating an example of a central maintenance apparatus of sensor for geophysical exploration according to FIG. 1 that passes an obstacle;

FIG. 3 is a schematic view illustrating a central maintenance apparatus of sensor for geophysical exploration;

FIG. 4 is a schematic view illustrating an example of a central maintenance apparatus of sensor for geophysical exploration of FIG. 3 that is mounted on a sensor rod;

FIG. 5 is a schematic view illustrating a process for a central maintenance apparatus of sensor for geophysical exploration of FIG. 3 to maintain a position of a sensor rod at a center of an inside of a borehole;

FIG. 6 is a schematic view illustrating a process for a central maintenance apparatus of sensor for geophysical exploration of FIG. 3 to stably and continuously move while rotating to thereby avoid an obstacle when encountered with the obstacle inside a borehole; and

FIG. 7 is a schematic view illustrating a process for a central maintenance apparatus of sensor for geophysical exploration of FIG. 3 to stably and continuously move while avoiding an obstacle according to a wing part being compressed when encountered with the obstacle inside a borehole while moving.

### DETAILED DESCRIPTION OF THE DRAWINGS

Exemplary embodiments of the present invention will be described in detail with reference to the accompanying drawings.

In describing reference numerals on elements of each drawing, like reference numerals designate like elements throughout the specification even though they are described in different drawings. In describing the exemplary embodiments, well-known functions or constructions are not described in detail to avoid obscuring the present disclosure in unnecessary detail.

Furthermore, it will be understood that, although the terms first, second, A, B, (a), (b), etc. may be used herein to describe various elements, these elements should not be limited by these terms in view of nature, sequence, or order. These terms are only used to distinguish one element from another.

Furthermore, various aspects of the subject matter disclosed herein are described with reference to a structure or a portion being formed on other structures, portions, or both. It will be understood that references to a structure being formed “on” or “above” another structure or portion contemplates that additional structure, portion, or both may intervene. References to a structure or a portion being formed “on” another structure or portion without an intervening structure or portion are described herein as being formed “directly on” the structure or portion. Similarly, it will be understood that when an element is referred to as being “connected”, “attached”, or “coupled” to another element, it can be directly connected, attached, or coupled to the other element, or intervening elements may be present. In contrast, when an element is referred to as being “directly connected”, “directly attached”, or “directly coupled” to another element, no intervening elements are present.

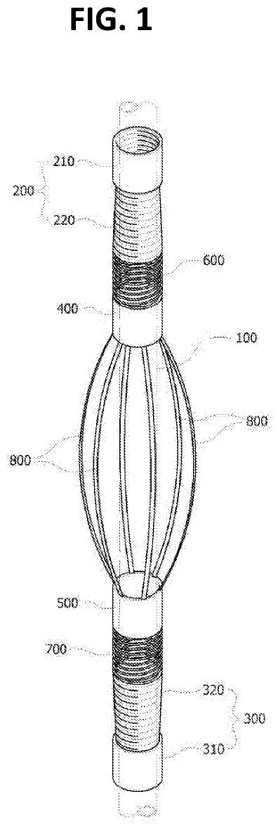

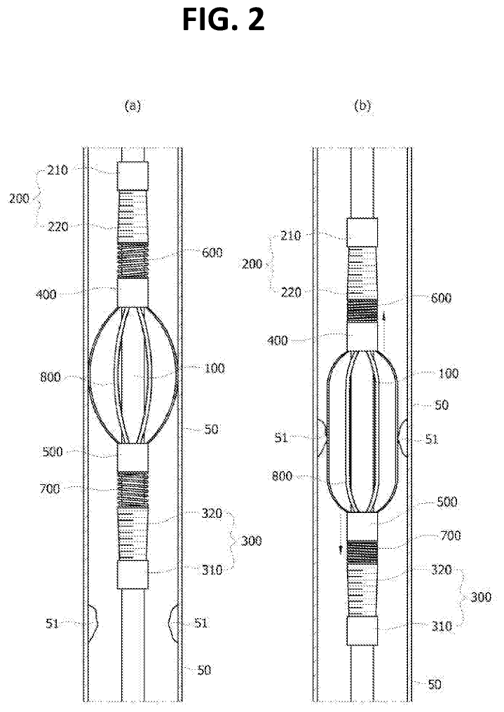

FIG. 1 is a schematic view illustrating an example of a conventional central maintenance apparatus of sensor for geophysical exploration, and FIG. 2 is a schematic view illustrating an example of the conventional central maintenance apparatus of sensor for geophysical exploration of FIG. 1 that passes an obstacle.

The conventional central maintenance apparatus of sensor for geophysical exploration includes, as illustrated in FIG. 1, an upper fixing member (200) fixed to an upper surface of a sensor rod (100), a bottom fixing member (300) spaced apart from the upper fixing member (200) at a predetermined distance and fixed to a bottom surface of the sensor rod (100), an upper moving member (400) spaced apart from the upper fixing member (200) at a predetermined distance and movably mounted on the sensor rod (100), a bottom moving member (500) spaced apart from the bottom fixing member (300) at a predetermined distance and movably mounted on the sensor rod (100), an upper elastic member (600) interposed between the upper fixing member (200) and the upper moving member (400) to vertically move the upper moving member (400) in response to compression and expansion, a bottom elastic member (700) interposed between the bottom fixing member (300) and the bottom moving member (500) to vertically move the bottom moving member (500) in response to compression and expansion and a plurality of frames (800) fixed at both ends to the upper moving member (400) and the bottom moving member (500) while being bent at a center to an outside of the sensor rod (100) to allow the center to be closely contacted to a borehole.

At this time, each of the upper fixing member (200) and the bottom fixing member (300) may include a fixing member (210, 310) and a connection member (220, 320), and may be connected to the upper elastic member (600) and the bottom elastic member (700) corresponded by each of the connection member (220, 320).

Here, the upper elastic member (600) and the bottom elastic member (700) may be formed with a spring, where, when the frame (800) closely contacted by a borehole (50) meets an obstacle (51) formed at an inside of the borehole (50) for the obstacle (51) to apply a pressure a contact surface of the frame (800), the upper elastic member (600) and the bottom elastic member (700) may be compressed by a pressure to elongate the length of the frame (800). As a result, the central maintenance apparatus of sensor for geophysical exploration according to the prior art may allow the sensor rod (100) to pass the obstacle (51) and to continuously descend.

At this time, when the frame (800) closely contacted to the obstacle (51) passes the obstacle (51), the frame (800) lacks a pressing power because of no contact with the obstacle (51), while the upper elastic member (600) and the bottom elastic member (700) may be expanded by restoring force to restore the length of the frame (800) to its original state.

Meantime, because the central maintenance apparatus of sensor for geophysical exploration according to the prior art includes an upper fixing member (200), a bottom fixing member (300), an upper moving member (400), a bottom moving member (500), an upper elastic member (600), a bottom elastic member (700), and a plurality of frames (800), the central maintenance apparatus of sensor for geophysical exploration according to the prior art thus described has suffered from disadvantages in that the manufacturing process is complicated and manufacturing cost is considerably high.

Furthermore, the central maintenance apparatus of sensor for geophysical exploration according to the prior art thus described has suffered from disadvantages in that the frame (800) descends while being contacted to the obstacle (51) when the frame (800) encounters the obstacle (51) at an inside of the borehole (50), such that the frame (800) may be generated with scratches or damages on the surface, and therefore, when the central maintenance apparatus of sensor for geophysical exploration according to the prior art thus described is used again, cumbersome works such as disassemble and re-assemble processes of each element are disadvantageously involved in order to replace the frame (800).

The present invention is provided to solve the aforementioned problems/disadvantages and therefore, it is an object of the present invention to provide a central maintenance apparatus of sensor for geophysical exploration configured to stably maintain and continuously move a sensor rod to a center of a borehole even if the apparatus meets an obstacle while descending or ascending along an internal diameter of the borehole, whereby the manufacturing process can be simplified and the manufacturing cost can be reduced with a reasonable price to allow using one time without recourse to re-use.

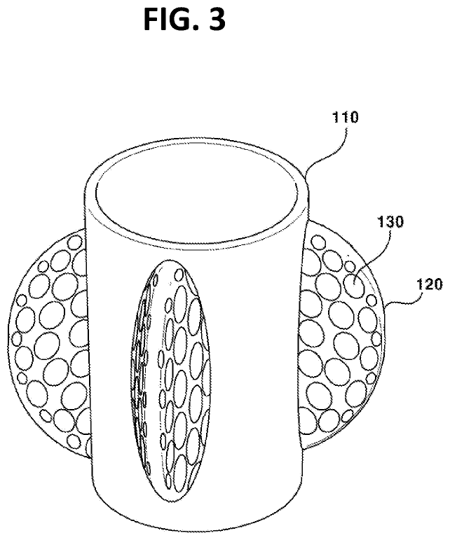

FIG. 3 is a schematic view illustrating a central maintenance apparatus of sensor for geophysical exploration (hereinafter referred to as “apparatus”) according to an exemplary embodiment of the present invention.

Referring to FIG. 3, the central maintenance apparatus of sensor for geophysical exploration according to an exemplary embodiment of the present invention may include a body part (110) and a plurality of wing parts (120).

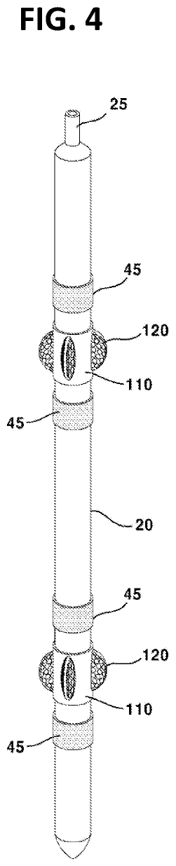

At this time, the body part (110) may be cylindrically formed to encompass a circumference of a sensor rod. Furthermore, an internal diameter of the body part (110) may be allowed to have a gap of 1˜2 mm from an external diameter of sensor rod, whereby rotation and movement of the apparatus can be eased from the sensor rod. In this case, the apparatus, as illustrated in FIG. 4, may be mounted on the sensor rod (20) in a plural number, and each end of the apparatus may be preferably mounted with a stopper (45) in order to restrict a scope of movement of the apparatus.

Each wing part (120) may be formed at an outer wall of the body part (110) in a convex, semi-elliptic shape to a lengthwise direction, and formed with a predetermined width, and may be formed therein with a cavity. That is, each wing part (120) may formed in a shape of protruding from an outer wall of body part (110), and the shape protruding from the body part (110) to a lengthwise direction may be formed with a half-elliptic shape and may be empty therein.

Through this structure, the apparatus according to an exemplary embodiment of the present invention may allow the wing part (120) to support an inner wall of the borehole when the sensor rod (20) is inputted into the borehole, whereby the sensor rod can be maintained at a center of the borehole.

Each wing part (120) may be formed with a plurality of through holes that passes through an inner cavity from an outside and may have a shape-changing elasticity when a pressure is applied to a direction of the body part. At this time, the wing part (120) may be formed at an area contacting the body part (110) with a plurality of through holes (130) each at a predetermined distance.

Through this structure, the apparatus according to an exemplary embodiment of the present invention may be such that, when an obstacle is encountered while moving inside a borehole, the integral type apparatus may rotate like sliding off the lateral surface of the semi-elliptic wing part (120) or the wing part (120) may be compressed to avoid the obstacle.

Furthermore, the apparatus according to an exemplary embodiment of the present invention has allowed air, water and foreign object to be easily introduced/discharged into the wing part (120) through the through holes (130) at the wing part (120), whereby, when an internal diameter of the borehole is temporarily narrowed, the wing part (120) is easily compressed, and when the internal diameter of the borehole is widened again, the wing part (120) is also widened, and the wing part (120) is restored to its original shape by the elasticity of the wing part (120).

Furthermore, the apparatus according to an exemplary embodiment of the present invention may be such that, when a pressure or a lateral force more than a predetermined force is applied to the wing part (120), the wing part (120) can be easily distanced from the body part (110) by the through hole (130) formed at a predetermined distance, whereby the sensor rod (20) is prevented from being in a situation of being entrapped within the borehole due to the apparatus being hitched by the obstacle, and even if some wing parts (120) are separated from the body part (110), other remaining wing parts (120) can support the inner wall of borehole to allow the sensor rod to be stably maintained at the center of borehole.

The apparatus according to an exemplary embodiment of the present invention may be formed with the body part (110) and the wing part (120), both of which are integrally formed. At this time, the body part (110) and the wing part (120) may be integrally formed by being manufactured by a 3D (Dimension) printer. In this case, the body part (110) and the wing part (120) may be formed with Thermoplastic Poly Urethane (TPU).

Through the abovementioned structure, the apparatus according to an exemplary embodiment of the present invention may be simple in manufacturing process, and may be manufactured with a reasonably low cost, whereby the apparatus can be easily replaced after one-time use with a new one without recourse to the necessity of repeated use.

Here, the wing part (120) may be formed on at least four (north, south, east and west) directions along a circumference of the body part (110). As a result, even if any one of the wing parts (120) is separated from the body part (110) by an obstacle during movement inside the borehole, the other remaining wing parts (120) can easily support an inner wall of the borehole to enable the sensor rod to be stably maintained along a center of the borehole.

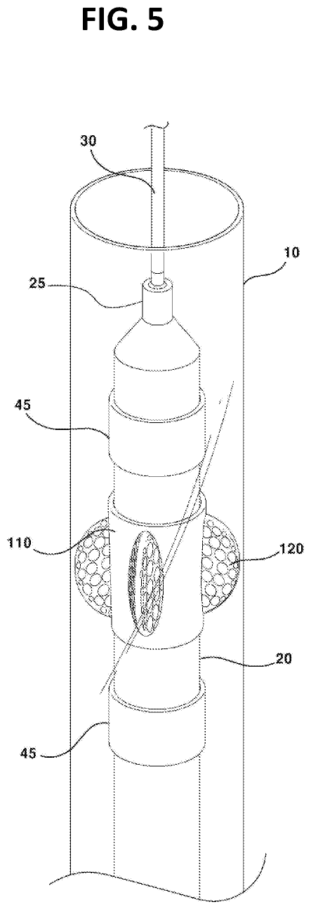

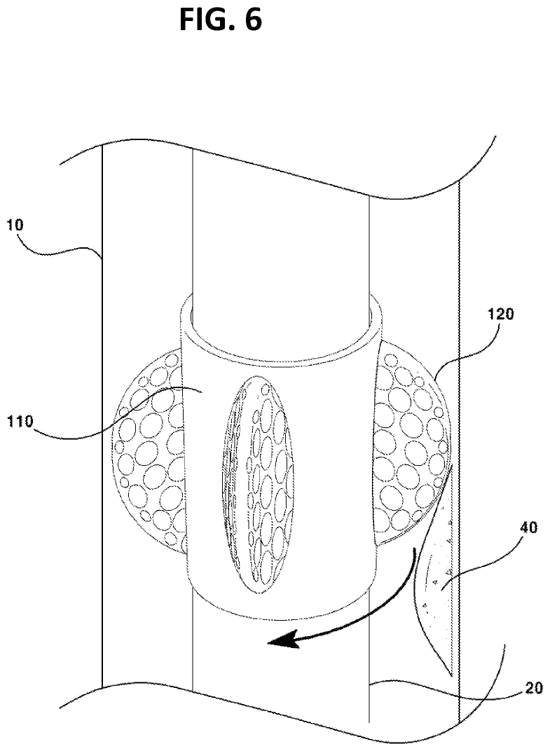

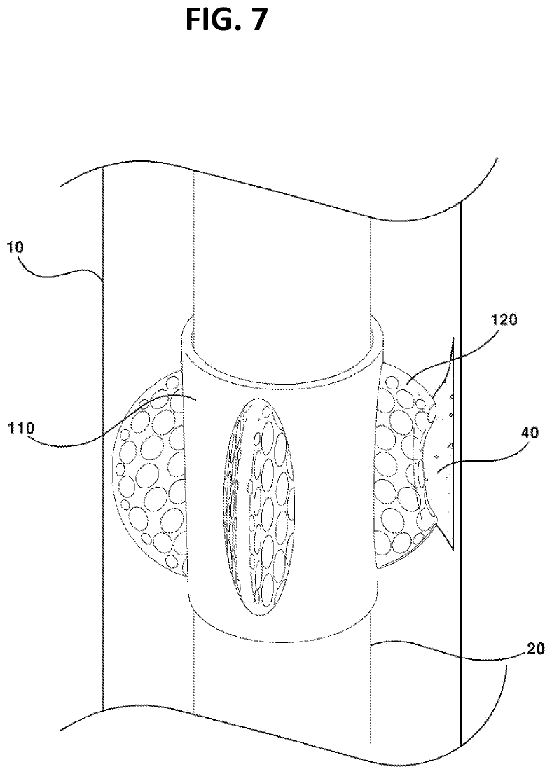

FIG. 5 is a schematic view illustrating a process for a central maintenance apparatus of sensor for geophysical exploration of FIG. 3 to maintain a position of a sensor rod at a center of an inside of a borehole, FIG. 6 is a schematic views illustrating a process for a central maintenance apparatus of sensor for geophysical exploration of FIG. 3 to stably and continuously move while rotating to thereby avoid an obstacle (40) when encountered with the obstacle inside a borehole, and FIG. 7 is a schematic view illustrating a process for a central maintenance apparatus of sensor for geophysical exploration of FIG. 3 to stably and continuously move while avoiding an obstacle (40) according to a wing part (120) being compressed when encountered with the obstacle inside a borehole while moving.

Referring to FIG. 4, the apparatus according to an exemplary embodiment of the present invention may be such that the body part (110) is cylindrically formed in order to encompass a circumference of the sensor rod (20). At this time, the body part (110) may be inserted into a plurality of areas including an upper end and a bottom end according to the length of the sensor rod (20).

Furthermore, inasmuch as the body part (110) must move or rotate along the sensor rod (20) instead of being attached/fixed to the sensor rod (20), a stopper (40) may be installed at an area below and above a scope in which the apparatus can move to allow the body part to move or rotate only within the scope.

Meantime, an upper end (25) of the sensor rod (20) may be connected to a traction part (30), whereby the body part (110) can ascend or descend by the traction of the traction part (30) within the borehole (10).

In this case, each wing part (120) can support an inner wall of borehole (10) to enable the sensor rod (20) to be stably positioned at a center of the borehole (10). Toward this end, a length from a central shaft of the body part (110) to a distal end of the wing part (120) may preferably be a length corresponding to a radius of the borehole (10).

Furthermore, the wing part (120) may be preferably installed on at least four directions including north, south, east and west directions along a circumference of the body part (110). The apparatus according to an exemplary embodiment of the present invention may be such that when the wing part (120) meets an obstacle (40) in the midst of the sensor rod (10) descending or ascending inside the borehole (10), the wing part (120) can be elastically compressed by the pressure applied to the obstacle (40) to a direction of the body part (110). At this time, because the body part (110) and the wing part (120) are formed with TPU material-wise, the surface thereof is slippery and has elasticity, and the wing part (120) is formed with a semi-elliptic streamlined shape. Thus, the apparatus according to an exemplary embodiment of the present invention may be such that, when the wing part (120) meets an obstacle (40) while the apparatus ascends or descends along an inside of the borehole (10), the wing part (120) may be compressed along a curved surface of obstacle, or rotate along a contact surface of the streamlined shape of wing part (120) contacting the obstacle (40), through which the obstacle can be easily passed.

Furthermore, the apparatus according to an exemplary embodiment of the present invention may be such that the wing part (120) is formed with through holes (130) to allow air, water and foreign object to easily introduced/discharged therethrough, whereby the compression of wing part (120) by the obstacle is prevented from being obstructed by materials inside the wing part (120).

In summary, a central maintenance apparatus of sensor for geophysical exploration is configured to locate a position of sensor for geophysical exploration at a center of borehole by mounting the central maintenance apparatus to an outside of the sensor for geophysical exploration that is inputted into the borehole.

A central maintenance apparatus of sensor for geophysical exploration, the apparatus includes a body part cylindrically formed to wrap a circumference of a sensor rod; and a plurality of wing parts lengthwise formed at an outer wall of the body part in a convex, semi-elliptic shape with a predetermined width, and formed therein with a cavity, wherein the wing part is formed with a plurality of through holes passing through the cavity from an outside, and has a shape-changing elasticity when a pressure is applied to a direction of the body part.

When an obstacle is encountered while moving inside a borehole, the wing part having a shape-changing elasticity can avoid the obstacle like sliding off the obstacle to allow the central maintenance apparatus of sensor to automatically rotate.

The wing part may be formed with a plurality of through holes passing through the cavity from an outside, and has a shape-changing elasticity when a pressure is applied to a direction of the body part.

The wing part may be formed with a plurality of through holes at an area contacting the body part, each at a predetermined gap.

The body part and the wing part may be integrally formed.

The wing part may be formed on at least four (north, south, east and west) directions along a circumference of the body part.

The body part and the wing part may be integrally formed by a 3D (Dimension) printer.

The body part and the wing part may be formed with Thermoplastic Poly Urethane (TPU).

The central maintenance apparatus of sensor for geophysical exploration can stably position a sensor rod at a center of borehole through a plurality of wing parts formed at a body part.

The central maintenance apparatus of sensor for geophysical exploration can stably move and maintain a sensor rod at a center of borehole while avoiding a protrusion through rotation due to elasticity of wing part and a gap between the body part and the sensor rod when encountered with the protrusion at an inner wall of the borehole while moving along the inner wall of the borehole.

The central maintenance apparatus of sensor for geophysical exploration has a wing part in the plurality of wing parts contacting an obstacle can be easily separated from the body part when the sensor rod is hitched by the obstacle, whereby a continuous movement can be implemented whereby the remaining wing parts along can maintain the sensor rod at a center of borehole.

The central maintenance apparatus of sensor for geophysical exploration is realized from a manufacturing process that is simple and the apparatus can be easily changed to cater to the size of the sensor rod and the borehole, and therefore, a manufacturing cost is reasonably low.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. The scope of the invention is indicated by the appended claims rather than by the foregoing description. All changes which come within the meaning and range of equivalency of the claims are to be embraced within their scope.

What is claimed is:

1. A central maintenance apparatus of sensor for geophysical exploration, the apparatus comprising:
a body part cylindrically formed to wrap a circumference of a sensor rod; and
a plurality of wing parts lengthwise formed at an outer wall of the body part in a convex, semi-elliptic shape with a predetermined width, and formed therein with a cavity;
wherein the wing part is formed with a plurality of through holes passing through the cavity from an outside, and has a shape-changing elasticity when a pressure is applied to a direction of the body part.

2. The central maintenance apparatus of claim 1, wherein the wing part is formed with a plurality of through holes at an area contacting the body part, each at a predetermined gap.

3. The central maintenance apparatus of claim 1, wherein the body part and the wing part are integrally formed.

4. The central maintenance apparatus of claim 3, wherein the body part and the wing part are integrally formed by a 3D (Dimension) printer.

5. The central maintenance apparatus of claim 3, wherein the body part and the wing part are formed with Thermoplastic Poly Urethane (TPU).

6. The central maintenance apparatus of claim 1, wherein the wing part is formed on at least four (north, south, east and west) directions along a circumference of the body part
